(19) United States
(12) Patent Application Publication
(10) Pub. No.: US 2018/0050362 A1
(43) Pub. Date: Feb. 22, 2018

(54) SPRAY GUN AND TRIGGER FOR THE SAME

(71) Applicant: SATA GmbH & Co. KG, Kornwestheim (DE)

(72) Inventors: Ralf GEHRUNG, Backnang (DE); Detlef REDECKER, Denkendorf (DE)

(73) Assignee: SATA GmbH & Co. KG, Kornwestheim (DE)

(21) Appl. No.: 15/679,461

(22) Filed: Aug. 17, 2017

(30) Foreign Application Priority Data
Aug. 19, 2016 (CN) 201620913023.6

(51) Int. Cl. B05B 12/00; B05B 1/30

(52) U.S. Cl. CPC B05B 12/008; B05B 7/02; B05B 12/002; B05B 1/306

(57) ABSTRACT

A spray gun and a trigger for the same. A one-armed trigger for a spray gun comprises a single connecting arm, secured to a left side or a right side of a spray gun body of the spray gun; an operating portion, provided at a lower end of the connecting arm; and an actuating component, provided on the connecting arm. The trigger can be more easily and reliably assembled onto a spray gun body and reduce the possibility of damaging parts of the spray gun.

### FIELD OF THE DISCLOSURE

The disclosure relates to the field of spraying, and more particularly to a spray gun and a trigger for the same.

### BACKGROUND

The spray gun is a tool commonly used in industry, for instance, it may be used to spray paint to surfaces of various articles such as furniture, machines and particularly vehicles (corresponding automobile bodies). The spray gun can comprise a material container for receiving a paint material and a spray gun body for spraying the paint material.

FIG. 1 shows a sectional view of a spray gun in the prior art. A spray gun 1 comprises a handle 21, a spray gun body 2 and a spray head 23 located in front of the spray gun body 2. The spray gun is supplied with compressed air via an air connection 3. The spray gun 1 has a cup connector 4, to which a cup can be connected. The cup contains a paint that is to be sprayed with the spray gun. The paint flows from the cup through a paint inlet 41 into a paint channel 42. A paint nozzle 6 is sealed by a paint needle 10, whereby the paint cannot leave the spray gun. When a trigger 11 is actuated, an air piston head 12, which seals an air supply 9 against air channels inside the spray gun body, is moved backwards and away from its seat. By that, the compressed air can flow through the inner air channels to flow to an air nozzle 5. The air nozzle 5 is a circular orifice provided to surround the paint nozzle 6. The compressed air is blown out of the air nozzle under pressure.

When the trigger 11 is pressed in excess of a certain point, the paint needle 10 is moved backwards, leaves the seat in the paint nozzle 6, then the paint nozzle 6 is opened. The paint in the paint channel 42 can flow out of the paint nozzle 6. The compressed air that is blown out of the air nozzle 5 generates a vacuum that sucks the paint out of the paint nozzle 6. Additionally, the paint is pressed out of the nozzle by the following paint.

FIG. 2 shows the trigger 11, which has two arms 11a and 11b, which clasp around the spray gun body when the trigger 11 is mounted. Each arm 11a, 11b has an upper hole and a lower hole. The upper holes are aligned to a borehole 13 in the gun body 2, before a trigger bolt 15 is inserted through the upper holes of the trigger arms 11a, 11b and the borehole 13. The trigger bolt 15 is preferably a hollow or not hollow cylindrical part. To avoid that the trigger bolt 15 is inserted into the spray gun body 2 to far, the trigger bolt 15 has a collar on one end, whose outer diameter is bigger than the inner diameters of the borehole 13 and the upper holes in the trigger arm 11b. The trigger bolt 15 is secured by a retainer clip 15a, which can be clipped into a groove in the other end of the trigger bolt 15. Preferably, the groove is circular around the trigger bolt 15. The trigger 11 is then rotatable around an axis of the borehole 13. After or before the trigger bolt 15 is or was arranged at the spray gun body 2, a trigger roller 16 is arranged. For that purpose, the lower holes of the trigger arms 11a, 11b are aligned to a window 14 in the upper spray gun body 2. The trigger roller 16 is inserted through the lower holes of the trigger arms 11a, 11b and the window 14. Like the trigger bolt 15, the trigger roller 16 can have a collar on one side and a groove on its other side. The trigger roller 16 can be secured by the retainer clip 16a. The trigger roller 16 can also be secured by the retainer clips 16a on both sides, if no collar is arranged at the trigger roller.

The trigger 11 still can rotate around the axis of borehole 13. When the trigger 11 is actuated, the trigger roller 16 is moved into the window 14. As shown in FIG. 2, the trigger roller 16 is provided with a borehole 16b. Through this borehole 16b, the paint needle 10, which is shown in FIG. 1, is arranged. As shown in FIG. 1, the paint needle 10 has a puller 17, which is permanently fixed to the paint needle 10.

When the trigger 11 is actuated, the trigger roller 16 is moved backward in a direction toward the puller 17. After some millimetres of movement, during which the air piston head 12 in FIG. 1 is moved out of its seat by what the air supply is activated, the trigger roller 16 touches the puller 17, and due to further backward movement of the trigger roller 16, it presses and pushes backwards the puller 17 and the paint needle connected therewith. By that, the air needle 10 steps out of a front orifice of the paint nozzle 6, and the paint can flow out of the paint nozzle 6.

The disadvantages of the prior art disclosed above include the following: It is necessary to remove the paint needle 10 and other parts out of the spray gun 1, e.g. when the spray gun 1 or parts thereof need to be cleaned or repaired. The spray gun 1 should be re-assembled after the cleaning or repair. When the paint needle 10 is arranged through the borehole in the trigger roller 16, the trigger roller 16 must have a certain orientation. This is because the axis of the borehole 16b may not have a too big angle to the axis of the paint needle 10. If the both axes coincide, it is easy to arrange the paint needle 10 in the borehole 16b, because the borehole 16b directs into the direction of the paint needle 10. However, if the trigger roller 16 is turned and the borehole 16b directs up- or downwards, it is not possible to arrange the paint needle 10 in the borehole 16b.

In the last case, the trigger roller 16 has to be partially pulled out of the trigger's holes, turned into the right position and then pushed into the trigger's holes without further turning the trigger roller 16.

This is time-consuming and can be frustrating for a user of the spray gun. Further, when the trigger roller 16 has a wrong orientation, it can happen that the user pushes the paint needle 10 against the outer surface of the trigger roller 16 or scratches it against an inner wall of the borehole 16b, by what the paint needle 10 can easily be damaged. As the paint needle is a very exactly and precisely manufactured part and critical for the spray quality of the spray gun, small damages can have a very bad effect to the spraying result. Further, as the paint needle acts as a sealing of the paint nozzle when the spray gun is not operated, a damaged paint needle can be the reason for a bad sealing effect. In that case, the paint can drop out of the paint nozzle.

In view of this, a patent document (CN 203508251 C) proposes an anti-rotation mechanism provided on a spray gun and used for orienting and locking a trigger roller, so as to solve the above-mentioned problems that the trigger roller needs to be oriented and it is not easy to install the trigger roller.

However, in the above patent document (CN 203508251 C), in the process of assembling the trigger to the spray gun body, before the trigger bolt 15 is inserted through the upper holes of the trigger arms 11a, 11b and the borehole 13, the upper holes of the two trigger arms 11a, 11b should be aligned to the borehole 13 in the spray gun body 2, and the lower holes of the trigger arms 11a, 11b should be aligned to the window 14 in the upper spray gun body 2, thus there is a problem that it is not easy for the user to detach and install the trigger.

### SUMMARY

In order to address the above-identified issues, the disclosure relates to a spray gun and a trigger for the same, wherein the trigger can be more easily and reliably assembled onto a spray gun body and reduce the possibility of damaging parts of the spray gun.

A first aspect of the disclosure provides a one-armed trigger for a spray gun, comprising a single connecting arm, secured to a left side or a right side of a spray gun body of the spray gun; an operating portion, provided at a lower end of the connecting arm; and an actuating component, provided on the connecting arm.

By providing the connecting arm of the trigger as a single arm, the installation can be completed just by aligning an installation component (for example, installation sleeve) provided on the single arm to the single installation hole on the spray gun body, thus it is easier to carry out the operation compared with the prior art in which the orifices on two arms of the U-shaped arm should be aligned to the orifices at both sides of the spray gun body for assembling, moreover, one side (a left side or a right side) of the spray gun body can be manufactured into a bigger flat surface, so that a sign marking the spray gun can be arranged on this bigger surface, i.e. the spray gun is made more pleasing.

In one preferable embodiment according to the disclosure, the one-armed trigger further comprises: an installation sleeve, provided at an upper end of the connecting arm; and a fastening means, passing through the installation sleeve, used to pivotably secure the one-armed trigger onto the spray gun body.

In one preferable embodiment according to the disclosure, the fastening means is a fastening screw, the fastening screw comprising: a rod portion; a head portion located at one end of the rod portion and having a diameter bigger than the rod portion; and a threaded portion located at the other end of the rod portion and having a diameter smaller than the rod portion.

In one preferable embodiment according to the disclosure, the fastening means comprises: a first fastening element, having a circumferential collar and a threaded portion used to be fastened to the spray gun body; a second fastening element, the second fastening element being co-axially fixed and connected with the first fastening element; and the installation sleeve, sleeved outside the first fastening element and the second fastening element, and arranged between the head portion of the second fastening element and the circumferential collar with a clearance along an axial direction.

In one preferable embodiment according to the disclosure, the circumferential collar and the threaded portion of the first fastening element are located at a first end of the first fastening element, the first fastening element internally has a threaded hole opened towards a second end of the first fastening element; the second fastening element has a rod portion and a head portion, the rod portion of the second fastening element matches the threaded hole of the first fastening element, and the head portion of the second fastening element presses against the second end of the first fastening element.

In one preferable embodiment according to the disclosure, the fastening means further comprises a ring, the head portion of the second second fastening element presses against the second end of the first fastening element in a manner of the ring being sandwiched between the head portion of the second fastening element and the second end of the first fastening element.

In one preferable embodiment according to the disclosure, the installation sleeve has a first end provided on the connecting arm and a second end against which the circumferential collar abuts, and a distance from the second end of the first fastening element to the second end of the installation sleeve is bigger than a distance from the first end of the installation sleeve to the second end of the installation sleeve.

In one preferable embodiment according to the disclosure, the connecting arm is provided with a recess to receive a head portion of the second fastening element.

In one preferable embodiment according to the disclosure, the installation sleeve and the connecting arm are formed in one piece.

In one preferable embodiment according to the disclosure, the first fastening element, the second fastening element and the ring are fixed against each other, and the installation sleeve is rotatable with respect to these components as a whole.

In one preferable embodiment according to the disclosure, the actuating component comprises a first extension element and a second extension element extending from the connecting arm, and a gap is defined between the first extension element and the second extension element.

In one preferable embodiment according to the disclosure, the first extension element and the second extension element extending from the connecting arm in a manner of non-parallel to each other.

In one preferable embodiment according to the disclosure, a width of the first extension element is different from an extending width of the second extension element.

In one preferable embodiment according to the disclosure, an extension element of the first extension element and the second extension element close to the operating portion of the trigger has a smaller width.

In one preferable embodiment according to the disclosure, the connecting arm has a recess in a lateral surface.

A second aspect of the disclosure provides a spray gun, comprising a spray gun body, a paint needle, a puller secured to the paint needle and a trigger, the paint needle being movably arranged inside the spray gun body, and the trigger comprising an actuating component configured to be capable of pushing the puller so as to make the paint needle to be moved, characterized in that the trigger is a one-armed trigger, the trigger has a single connecting arm secured to a left side or a right side of the spray gun body, and the actuating component is provided on the connecting arm of the trigger.

In one preferable embodiment according to the disclosure, the trigger further comprises: an installation sleeve, provided at an upper end of the connecting arm; and a fastening means, passing through the installation sleeve, used to pivotably secure the one-armed trigger onto the spray gun body.

In one preferable embodiment according to the disclosure, the spray gun body is provided with an installation hole for the installation sleeve and the fastening means to be inserted thereinto so as to pivotably secure the one-armed trigger onto the spray gun body.

In one preferable embodiment according to the disclosure, the installation hole comprises a first section having a first diameter and a second section having a second diameter smaller than the first diameter.

In one preferable embodiment according to the disclosure, the fastening means is a fastening screw, the fastening screw comprising: a rod portion, received in the installation sleeve; a head portion located at one end of the rod portion and having a diameter bigger than the rod portion; and a threaded portion located at the other end of the rod portion and having a diameter smaller than the rod portion, the threaded portion being fastened into the second section of the installation hole.

In one preferable embodiment according to the disclosure, the fastening means comprises: a first fastening element, having a circumferential collar and a threaded portion used to be fastened into the second section of the installation hole; a second fastening element, the second fastening element being co-axially fixed and connected with the first fastening element; and the installation sleeve, sleeved outside the first fastening element and the second fastening element, and arranged between a head portion of the second fastening element and the circumferential collar with a clearance along an axial direction.

In one preferable embodiment according to the disclosure, the circumferential collar and the threaded portion of the first fastening element are located at a first end of the first fastening element, the first fastening element internally has a threaded hole opened towards a second end of the first fastening element; the second fastening element has a rod portion and a head portion, the rod portion of the second fastening element matches the threaded hole of the first fastening element, and the head portion of the second fastening element presses against the second end of the first fastening element.

In one preferable embodiment according to the disclosure, the fastening means further comprises a ring, the head portion of the second fastening element presses against the second end of the first fastening element in a manner of the ring being sandwiched between the head portion of the second fastening element and the second end of the first fastening element.

In one preferable embodiment according to the disclosure, the installation sleeve has a first end provided on the connecting arm and a second end against which the circumferential collar abuts, and a distance from the second end of the first fastening element to the second end of the installation sleeve is bigger than a distance from the first end of the installation sleeve to the second end of the installation sleeve.

In one preferable embodiment according to the disclosure, the connecting arm is provided with a recess so that the rod portion of the second fastening element passes through the recess to be thereby fastened into the threaded hole of the first fastening element, and the head portion of the second fastening element is arranged in the recess.

In one preferable embodiment according to the disclosure, the first fastening element, the second fastening element and the ring are fixed against each other, and the installation sleeve is rotatable with respect to these components as a whole.

In one preferable embodiment according to the disclosure, there is a gap between the first end of the installation sleeve provided on the connecting arm and an end of the ring abutting against the second end of the first fastening element.

In one preferable embodiment according to the disclosure, the installation sleeve and the connecting arm are formed in one piece.

In one preferable embodiment according to the disclosure, the actuating component comprises a first extension element and a second extension element extending from the connecting arm, and a gap is defined between the first extension element and the second extension element so as to make the paint needle pass therethrough.

In one preferable embodiment according to the disclosure, the gap defined between the first extension element and the second extension element is increased as far away from the puller.

In one preferable embodiment according to the disclosure, a width of the first extension element is different from an extending width of the second extension element.

In one preferable embodiment according to the disclosure, an extension element of the first extension element and the second extension element close to an operating portion of the trigger has a smaller width.

In one preferable embodiment according to the disclosure, the spray gun further comprises a protective element, and the protective element is sleeve-connected on the actuating component so as to push the puller.

In one preferable embodiment according to the disclosure, a left side or a right side of the spray gun body is provide with a window so as to expose the paint needle and the puller, and the connecting arm is assembled to the spray gun body in a manner of covering the window.

In one preferable embodiment according to the disclosure, the connecting arm has a recess in a lateral surface.

The trigger and the spray gun according to the disclosure provide convenience of disassembling between the trigger and the spray gun, and can make the appearance of the spray gun more pleasing, meanwhile also can avoid damage to parts such as the paint needle.

### BRIEF DESCRIPTION OF THE DRAWINGS

The drawings constitute a portion of the description for further understanding of the disclosure. These drawings illustrate the embodiments of the disclosure and explain the principle of the disclosure together with the description. In the drawings, the same part is represented by the same reference sign. In the drawings,

FIG. 1 is a sectional view showing a spray gun in the prior art.

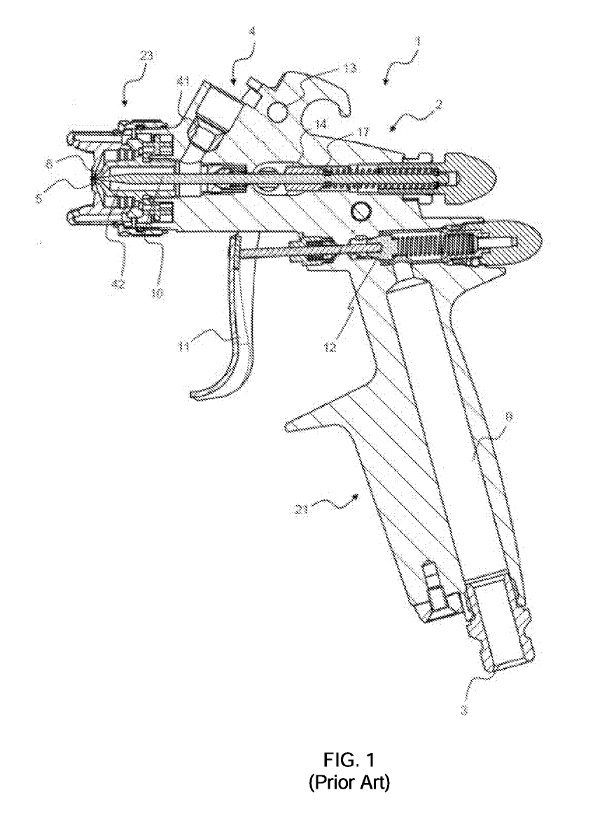

FIG. 2 is a perspective diagram showing a trigger of the spray gun in the prior art.

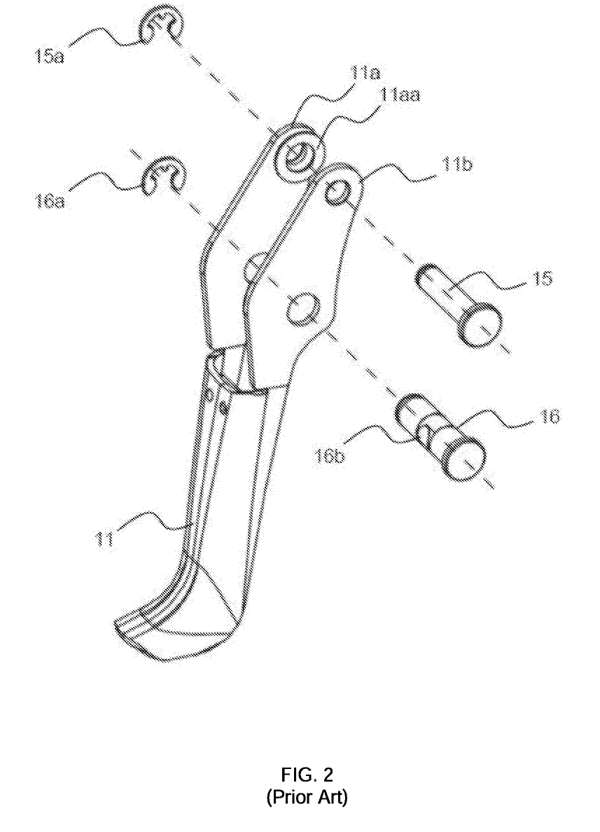

FIG. 3 is a perspective diagram showing the spray gun in the prior art.

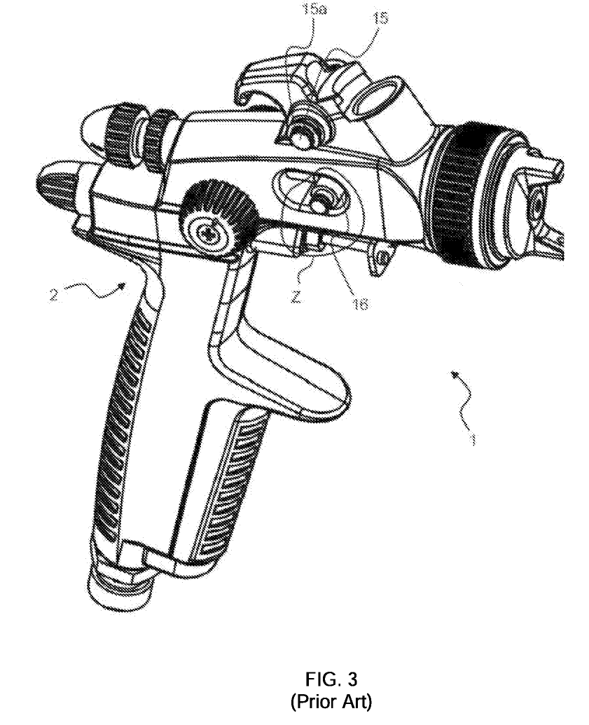

FIG. 4A and FIG. 4B are respectively exploded diagrams showing a spray gun according to the disclosure as seen from the opposite sides.

FIG. 5A and FIG. 5B respectively are exploded diagrams showing a perspective view and a front view of a trigger according to the disclosure;

FIG. 5C is a side view of the trigger with paint needle with the gun body being removed according to an embodiment of the disclosure when the trigger is not activated; and FIG. 5D is a side view of the trigger with paint needle with the gun body being removed when the trigger is activated.

FIG. 6A is an enlarged diagram of sectional view showing one example of a manner of assembling the trigger as shown in FIG. 5A to a spray gun body.

FIG. 6B is an enlarged diagram of sectional view showing another example of a manner of assembling the trigger as shown in FIG. 5A to a spray gun body.

FIG. 6C is a diagram showing an installation hole provided on the spray gun body according to the disclosure for assembling the trigger as shown in FIG. 5A.

FIG. 7A is an enlarged diagram showing yet another example of a manner of assembling the trigger as shown in FIG. 5A to the spray gun body according to the disclosure.

FIG. 7B is an enlarged diagram showing the screw provided in the FIG. 7A.

FIG. 8 is an assembling diagram showing a protective element and the trigger comprised in the spray gun according to the disclosure.

### DETAILED DESCRIPTION OF THE EMBODIMENTS

In the detailed description below, reference is made to the figures which constitute a portion of the present description, wherein embodiments which can implement the disclosure are illustratively shown. With regard to the figures, directional terms such as “top”, “bottom”, “inner”, “outer” and so on are used with reference to directions in the described figures. Since components in the examples of the disclosure can be placed in many different directions, the directional terms are merely used for illustration without any restrictions. It should be understood that other examples can be used, and structural or logical changes can be made without departing from the scope of the disclosure. Therefore, the following detailed description should not be construed as limiting, and the disclosure is defined by the attached claims.

It should be understood that features in different exemplary examples described herein can be combined with each other unless otherwise specified.

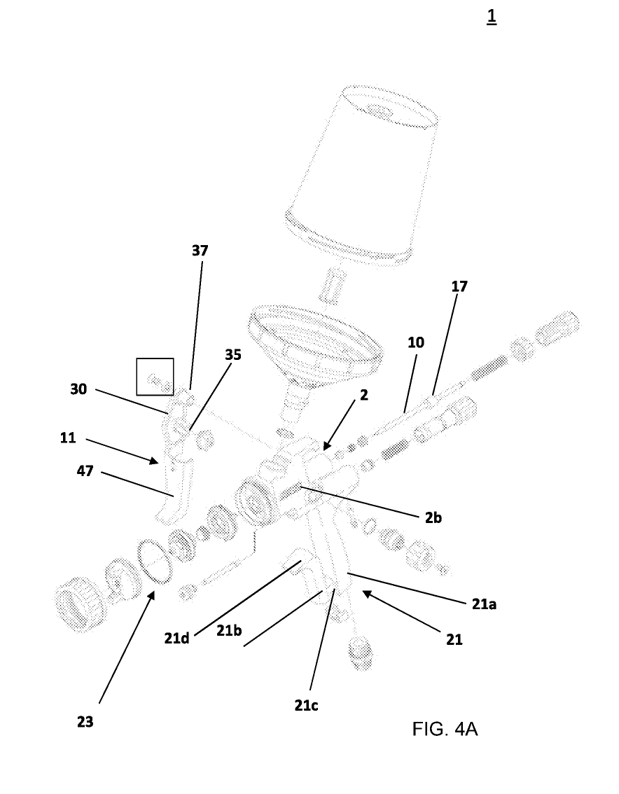

Reference will be made to FIGS. 4A and 4B to describe in detail the spray gun according to an example of the disclosure, wherein FIGS. 4A and 4B are perspective diagrams respectively showing the spray gun according to the example of the disclosure as viewed from the opposite sides of the spray gun.

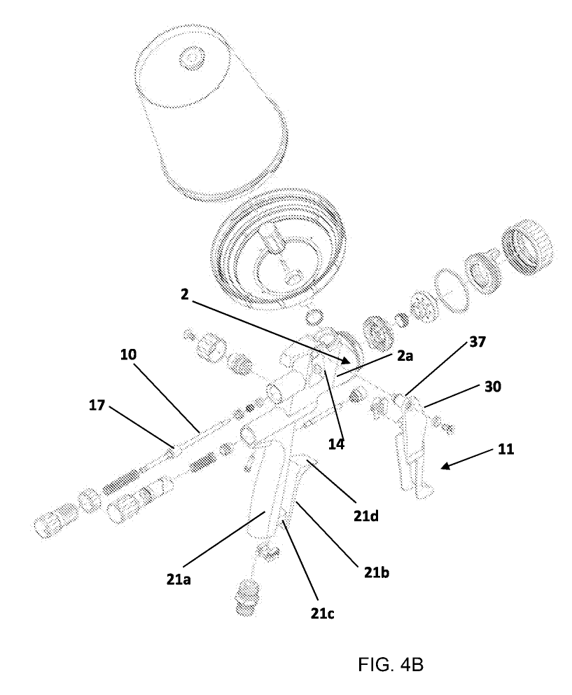

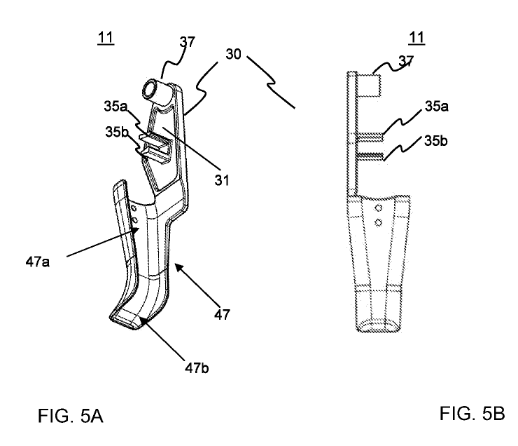

As shown in FIGS. 4A and 4B, a spray gun 1 according to the disclosure comprises a spray gun body 2, a spray head 23 engaged to the head of the spray gun body 2, a handle 21 engaged to a lower part of the spray gun body 2, a paint needle 10, a puller 17 secured to the paint needle 10 and a trigger 11, wherein the paint needle 10 is movably arranged inside the spray gun body 2. The trigger 11 comprises an actuating component 35 configured to be capable of pushing the puller 17 so as to make the paint needle 10 to be moved away from the spray head 23. Moreover, the trigger 11 is a one-armed trigger, that is, the trigger 11 comprises a single connecting arm 30 secured to a left side or a right side of the spray gun body 2 and an operating portion 47 provided at a lower end of the connecting arm 30, and the actuating component 35 is provided on the connecting arm 30 of the trigger 11. Besides, the operating portion 47 comprises a gripping portion 47a and a blocking portion 47b preventing fingers gripping on the gripping portion 47a from sliding downwards, as shown in FIG. 5A.

Further, the handle 21 comprises a first portion 21a having a first end connected to the spray gun body 2; a second portion 21b separated from the first portion 21a by a distance; and a connecting portion 21c connecting a second end of the first portion 21a with a first end of the second portion 21b. The second end of the second portion 21b is provided with a blocking portion 21d, and this blocking portion 21d is used to prevent the fingers gripping the second portion 21b from sliding upwards. Gun body 2, handle 21 and handle parts 21a, 21b, 21c and 21d are preferably made in one piece, particularly the part can be manufactured by forging.

Since the trigger 11 having a single connecting arm 30 is used, during the process of assembling the trigger 11 to the spray gun body 2, the installation inconvenience in the prior art that two arm portions of the U-shaped arm should be aligned to two installation holes on the spray gun body and meanwhile the hole of the actuating component should be aligned to the paint needle so that the installation can be completed is overcome, that is, the installation and dismantling convenience is improved.

Besides, the spray gun body 2 of the spray gun 1 has a first surface 2a for installing the connecting arm and a second surface 2b opposite to the first surface 2a, wherein the first surface 2a is provided with a window 14 so as to expose the paint needle 10 and the puller 17, and the second surface 2b is in an integral bulk-shape so as to sign corresponding picture, character and so on, for example, Logo or trademark and the like of a company, so that the spray gun seems more pleasing.

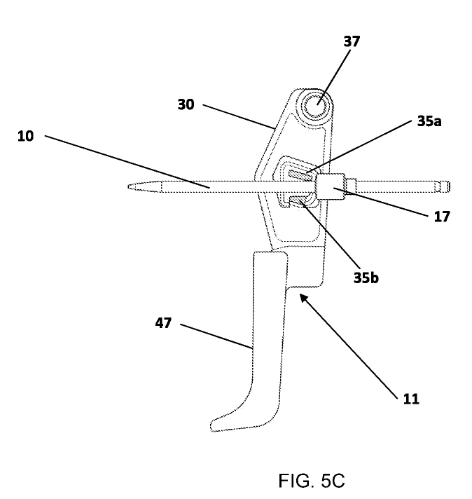

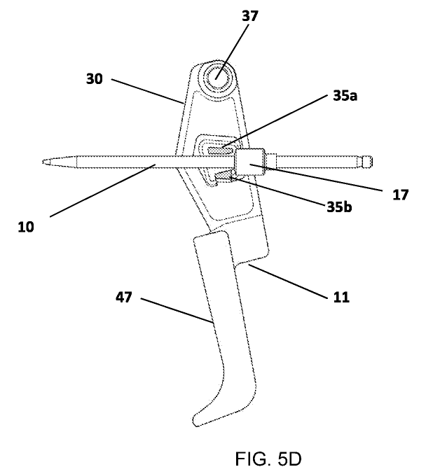

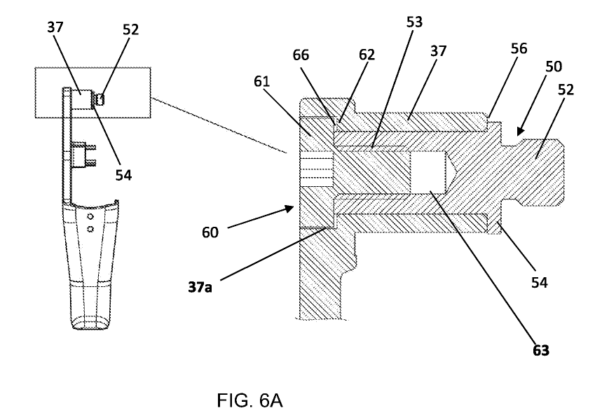

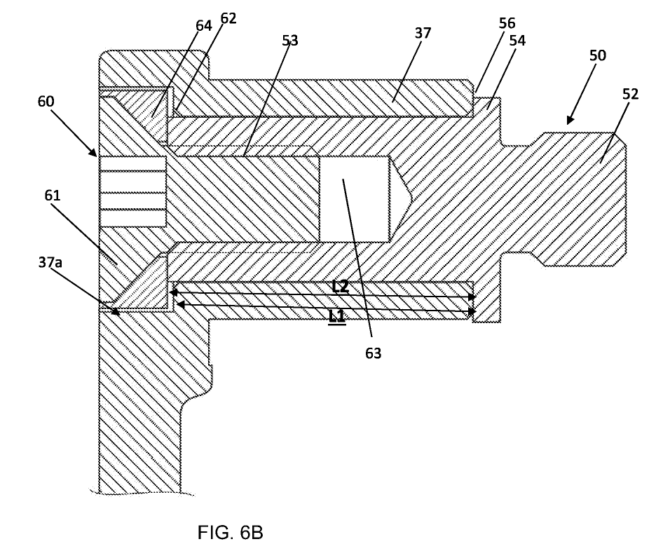

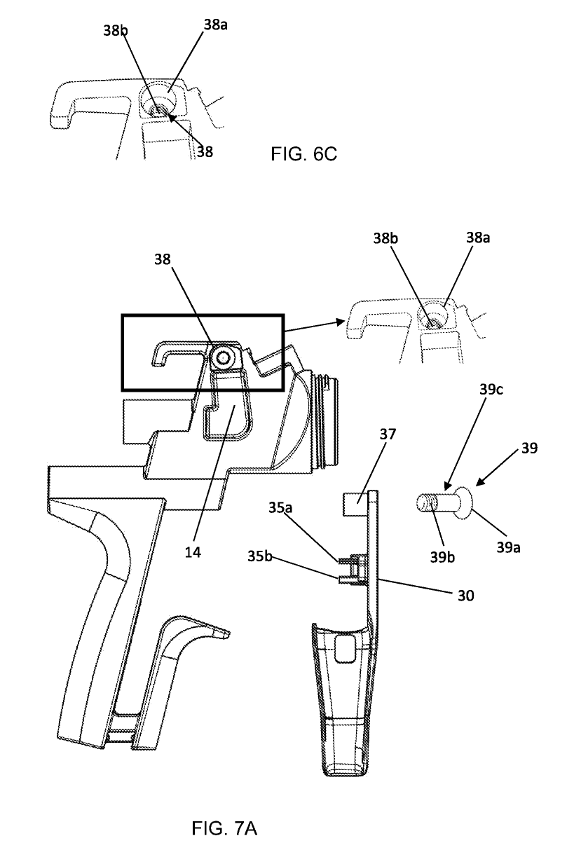

Specifically, as shown in FIGS. 4A and 4B, FIG. 5A and FIG. 5B, the trigger 11 comprises: the single connecting arm 30 secured to the left side or the right side of the spray gun body 2 of the spray gun 1; the operating portion 47 provided at a lower end of the connecting arm 30; the actuating component 35 provided on the connecting arm 30; an installation sleeve 37 provided at an upper end of the connecting arm 30; and a fastening means (for example, shown by a box in FIG. 4A) passing through the installation sleeve 37 and used to pivotably secure the trigger 11 onto the spray gun body 2, wherein FIG. 6A and FIG. 7A specifically show the composition of the fastening means, and the fastening means will be specifically described below with reference to FIG. 6A and FIG. 7A.

Further as shown in FIGS. 4A and 4B, FIG. 5A and FIG. 5B, the actuating component 35 comprises a first extension element 35a and a second extension element 35b extending from the connecting arm 30, and a gap is defined between the first extension element 35a and the second extension element 35b so as to make the paint needle 10 pass through. Specifically, after the trigger 11 is assembled onto the spray gun body 2 of the spray gun 1, parts of the connecting arm 30 provided with the first extension element 35a and the second extension element 35b cover the window 14, and the paint needle 10 passes through the gap defined between the first extension element 35a and the second extension element 35b, so that when the trigger 11 is operated to spray the paint, the first extension element 35a and the second extension element 35b can push the puller 17 so as to make the paint needle 10 to be moved toward a direction away from the paint nozzle, thus leaving a seat in the paint nozzle, and then the paint nozzle is opened, so that the paint in a paint channel can flow out of the paint nozzle.

Besides, although FIG. 4A and FIG. 5A show that the first extension element 35a and the second extension element 35b extend perpendicularly to the connecting arm 30 and are parallel to each other, i.e. a gap defined between the first extension element 35a and the second extension element 35b is uniform, preferably and advantageously, the first extension element 35a and the second extension element 35b extend perpendicularly to the connecting arm 30 in a manner of non-parallel to each other, the gap between the first extension element 35a and the second extension element 35b is gradually decreased towards the puller 17, that is, the gap between the first extension element 35a and the second extension element 35b is gradually increased as being away from the puller 17. With such configuration, a moving space of the paint needle 10 can be increased, so that the paint needle 10 can be protected against damage caused by collision of the paint needle 10 with the first extension element 35a or the second extension element 35b.

The trigger 11, particularly the connecting arm 30, may have a recess 31 in its lateral surface, preferably on an inner surface and preferable around the first extension element 35a and the second extension element 35b. By that, material can be saved and the trigger 11 becomes lighter.

Preferably, a width of the first extension element 35a is different from an extending width of the second extension element 35b, as shown in FIG. 5C. More preferably, the extension element of the first extension element 35a and the second extension element 35b close to the operating portion 47 of the trigger 11 has a smaller width, that is, the extending width of the second extension element 35b is smaller than the extending width of the first extension element 35a. The reason for that is the following: The trigger is moving along a circular path section when it is activated, as it is rotationally fixed to the spray gun body at one point. By that, the lower part of the trigger is moving along a longer way than the upper part of the trigger. If the extension elements would have the same width, as the lower extension element moves along a longer way than the upper extension element, the length of the window in the gun body would have to be bigger in its lower area than in its upper area, to provide the lower extension element enough space for its movement. By that the lower extension element is smaller in width than the upper extension element, the window in the gun body may have a rectangular shape. Preferably, the extension element having the smaller width is thicker than the extension element having with the bigger width to ensure that the stability of the extension element is sufficient.

Besides, the spray gun body 2 is provided with an installation hole 38 (as shown in FIG. 6C) for the installation sleeve 37 and the fastening means to be inserted thereinto so as to pivotably secure the trigger 11 onto the spray gun body 2. Further, as shown in FIG. 6C, the installation hole 38 comprises a first section 38a having a first diameter and a second section 38b having a second diameter smaller than the first diameter. A step is formed between the first section 38a and the second section 38b.

Next, various examples of composition of the fastening means used for assembling the trigger 11 onto the spray gun body 2 is described with reference to FIGS. 6A and 6B and FIG. 7A.

### Example 1

As shown in FIG. 6A, the fastening means comprises: a first fastening element 50, comprising a circumferential collar 54 and a threaded portion 52 provided at a first end of the first fastening element 50 and a threaded hole 53 internally opened towards a second end of the first fastening element 50, wherein the threaded portion 52 is fastened into the second section 38b of the installation hole 38 of the spray gun body 2; a second fastening element 60, having a rod portion 63 and a head portion 61, wherein the rod portion 63, which preferably has an outer thread, of the second fastening element 60 matches the threaded hole 53 of the first fastening element 50 so as to make the second fastening element 60 to be co-axially fixed and connected with the first fastening element 50, and the head portion 61 of the second fastening element 60 presses against the second end of the first fastening element 50, wherein the installation sleeve 37 is sleeved outside the first fastening element 50 and the second fastening element 60, and is arranged between the head portion 61 of the second fastening element 60 and the circumferential collar 54. The fixing element 60 may be for example a cylinder head screw or a hexagon head screw.

Alternatively, the fastening means further can comprise a ring 64, and the ring 64 is sandwiched between the head portion 61 of the second fastening element 60 and the second end of the first fastening element 50 and presses against the second end of the first fastening element 50, as shown in FIG. 6B. In this case, the fixing element 60 can for example be a counterhead screw.

Besides, the installation sleeve 37 has a first end provided on the connecting arm 30 and a second end against which the circumferential collar 54 abuts, and a distance L2 from the second end of the first fastening element 50 to the second end of the installation sleeve 37 is bigger than a distance L1 from the first end of the installation sleeve 37 to the second end of the installation sleeve 37. Or in other words, a distance L2 from the second end of the first fastening element 50 to the circumferential collar 54 of the first fastening element 50 is bigger than a distance L1 from the first end of the installation sleeve 37 to the second end of the installation sleeve 37.

A recess 37a is provided on the connecting arm 30 so that the rod portion 62 of the second fastening element 60 passes through the recess 37a to be thereby fastened into the threaded hole 53 of the first fastening element 50, and the head portion 61 of the second fastening element 60 is arranged in the recess 37a.

Besides, the first fastening element 50, the second fastening element 60 and the ring 64 are fixed against each other, and the installation sleeve 37 is rotatable with respect to these components as a whole.

There is a gap between the first end of the installation sleeve 37 provided on the connecting arm 30 and an end of the ring 64 abutting against the second end of the first fastening element 50.

Through the above-mentioned structure, the second end of the first fastening element 50 is enabled to protrude into the recess 37a of the connecting arm 30, thus a gap 66 can be established between a surface 62 of the first end of the installation sleeve 37 and the head portion 61 or the ring 64, so as to allow the first fastening element 50, the second fastening element 60 and the ring 64 to act as a whole to be rotatable with respect to the installation sleeve 37, or, as the the first fastening element 50, the second fastening element 60 and the ring 64 as a whole are fixed in the gun body, the installation sleeve 37 and the trigger 11, to which the installation sleeve 37 is attached, are rotatable with respect to these components as a whole.

The installation sleeve 37 can be formed in one piece with the operating portion 47 and the connecting arm 30 of the trigger 11, and the circumferential collar of the first fastening element 50 abuts against a surface 56 of the second end of the installation sleeve 37.

For the above-mentioned structure, in the situation that the threaded portion 52 of the fastening means is screwed into the second section 38b of the installation hole 38 of the spray gun body 2, meanwhile the installation sleeve 37 is received in the first section 38a, when the trigger 11 is actuated, the connecting arm 30 having the installation sleeve 37 and the operating portion 47 are rotatable with respect to the first fastening element 50 and the second fastening element 60, so that the first extension element 35a and the second extension element 35b can push the puller 17 to move towards a direction away from the paint nozzle, so that the paint is sprayed out of the paint nozzle.

### Example 2

As shown in FIGS. 7A and 7B, the fastening means is a fastening screw 39, comprising: a rod portion 39c received in the installation sleeve 37; a head portion 39a located at one end of the rod portion 39c and having a diameter bigger than the rod portion 39c; and a threaded portion 39b located at the other end of the rod portion 39c and having a diameter smaller than the rod portion 39c, the threaded portion 39b being fastened into the second section 38b of the installation hole 38, and the installation sleeve 37 being received in the first section 38a of the installation hole 38. The length of the fastening screw 39 is such that the installation sleeve 37 is not tightly fixable in the installation hole 38, but even is the fastening screw 39 is pulled tight, the installation sleeve 37 and the trigger 11 are still able to rotate around the fastening screw 39.

When the trigger 11 is mounted onto the spray gun body 2, the first extension element 35a and the second extension element 35b are located in front of the puller 17, so that when the trigger 11 is actuated, the first extension element 35a and the second extension element 35b push the puller 17 backwards to open the nozzle.

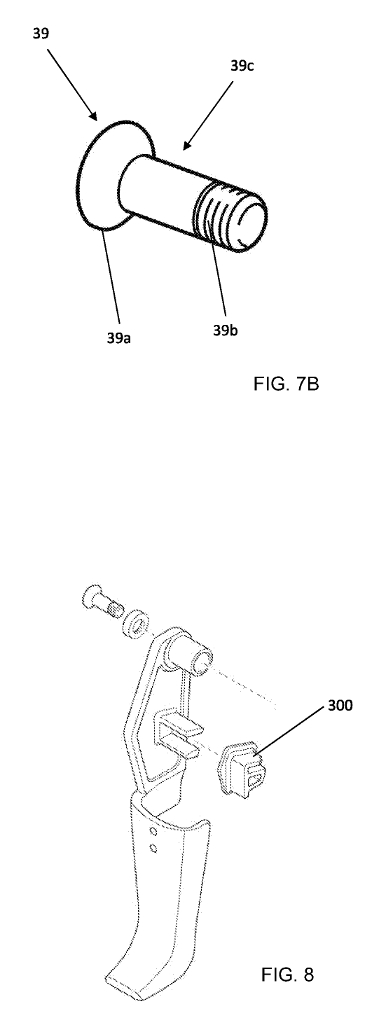

Besides, in the above-mentioned example, the first extension element 35a and the second extension element 35b can be covered by a protective element 300 so as to push the puller through the protective element 30, as shown in FIG. 8. The material of the protective element 300 may be a soft material, for example, plastic and so on. By that, the puller can be protected against collision and damages caused by the first extension element and the second extension element made from a hard material, thus prolonging the service life of the spray gun.

Further, as it can be seen in FIG. 5C and 5D, when the trigger is not activated, the puller is in contact with the upper first extension element 35a, when the trigger is activated, the puller is in contact with the upper first extension element 35a as well as with the lower second extension element 35b or even just with the lower second extension element 35b. This change from the first to the second extension element generates a sound and the user feels the change when activating the trigger. With the protective element 300, as the surface of the protective element 300 that is in contact with the puller is rounded, activation of the trigger is smoother and more uniform.

It is noted that in Example 1 and Example 2 provided above, when the trigger 11 is actuated to spray the paint, the blocking portion 47b of the trigger 11 and the blocking portion 21b of the handle are aligned to each other, so that the trigger 11 can be conveniently and easily operated so as to spray the paint.

Although the trigger described above is described taking the structure of the spray gun (FIG. 4A) provided in the disclosure as an example, the above-mentioned trigger also can be applied to sprays with other structures, which can be easily designed by those ordinarily skilled in the art after reading the present application, and details will not be given herein.

For the descriptive purpose, a plurality of improvements on the disclosure are described through several embodiments above. However, those skilled in the art should understand that various above improvements on the disclosure absolutely can be independently applied to the spray gun, and it is unnecessary to combine all the features to use.

The descriptions above are only preferable examples of the application, which are not used to restrict the disclosure. For those skilled in the art, the disclosure may have various changes and variations. Any modifications, equivalent substitutions, improvements etc. within the spirit and principle of the disclosure shall all be included in the scope of protection of the disclosure.

What is claimed is:

1. A one-armed trigger for a spray gun, comprising:
a single connecting arm, secured to a left side or a right side of a spray gun body of the spray gun;
an operating portion, provided at a lower end of the connecting arm;
an actuating component, provided on the connecting arm.

2. The one-armed trigger for a spray gun according to claim 1, further comprising:
an installation sleeve, provided at an upper end of the connecting arm; and
a fastening means, passing through the installation sleeve, used to pivotably secure the one-armed trigger onto the spray gun body.

3. The one-armed trigger for a spray gun according to claim 2, wherein the fastening means is a fastening screw, the fastening screw comprising:
a rod portion;
a head portion located at one end of the rod portion and having a diameter bigger than the rod portion; and
a threaded portion located at the other end of the rod portion and having a diameter smaller than the rod portion.

4. The one-armed trigger for a spray gun according to claim 2, wherein the fastening means comprises:
a first fastening element, having a circumferential collar and a threaded portion used to be fastened to the spray gun body;
a second fastening element, the second fastening element being co-axially fixed and connected with the first fastening element; and
the installation sleeve, sleeved outside the first fastening element and the second fastening element, and arranged between the head portion of the second fastening element and the circumferential collar with a clearance along an axial direction.

5. The one-armed trigger for a spray gun according to claim 4, wherein
the circumferential collar and the threaded portion of the first fastening element are located at a first end of the first fastening element, the first fastening element internally has a threaded hole opened towards a second end of the first fastening element;
the second fastening element has a rod portion and a head portion, the rod portion of the second fastening element matches the threaded hole of the first fastening element, and the head portion of the second fastening element presses against the second end of the first fastening element.

6. The one-armed trigger for a spray gun according to claim 5, wherein the fastening means further comprises a ring, the head portion of the second second fastening element presses against the second end of the first fastening element in a manner of the ring being sandwiched between the head portion of the second fastening element and the second end of the first fastening element.

7. The one-armed trigger for a spray gun according to claim 5, wherein the installation sleeve has a first end provided on the connecting arm and a second end against which the circumferential collar abuts, and a distance from the second end of the first fastening element to the second end of the installation sleeve is bigger than a distance from the first end of the installation sleeve to the second end of the installation sleeve.

8. The one-armed trigger for a spray gun according to claim 5, wherein the connecting arm is provided with a recess to receive a head portion of the second fastening element.

9. The one-armed trigger for a spray gun according to claim 2, wherein the installation sleeve and the connecting arm are formed in one piece.

10. The one-armed trigger for a spray gun according to claim 6, wherein the first fastening element, the second fastening element and the ring are fixed against each other, and the installation sleeve is rotatable with respect to these components as a whole.

11. The one-armed trigger for a spray gun according to claim 1, wherein the actuating component comprises a first extension element and a second extension element extending from the connecting arm, and a gap is defined between the first extension element and the second extension element.

12. A spray gun, comprising a spray gun body, a paint needle, a puller secured to the paint needle and a trigger, the paint needle being movably arranged inside the spray gun body, and the trigger comprising an actuating component configured to be capable of pushing the puller so as to make the paint needle to be moved, wherein the trigger is a one-armed trigger, the trigger has a single connecting arm secured to a left side or a right side of the spray gun body, and the actuating component is provided on the connecting arm of the trigger.

13. The spray gun according to claim 12, wherein the trigger further comprises:
an installation sleeve, provided at an upper end of the connecting arm; and
a fastening means, passing through the installation sleeve, used to pivotably secure the one-armed trigger onto the spray gun body.

14. The spray gun according to claim 13, wherein the spray gun body is provided with an installation hole for the installation sleeve and the fastening means to be inserted thereinto so as to pivotably secure the one-armed trigger onto the spray gun body.

15. The spray gun according to claim 14, wherein the installation hole comprises a first section having a first diameter and a second section having a second diameter smaller than the first diameter.

16. The spray gun according to claim 15, wherein the fastening means is a fastening screw, the fastening screw comprising:
a rod portion, received in the installation sleeve;
a head portion located at one end of the rod portion and having a diameter bigger than the rod portion; and
a threaded portion located at the other end of the rod portion and having a diameter smaller than the rod portion, the threaded portion being fastened into the second section of the installation hole.

17. The spray gun according to claim 15, wherein the fastening means comprises:
a first fastening element, having a circumferential collar and a threaded portion used to be fastened into the second section of the installation hole;
a second fastening element, the second fastening element being co-axially fixed and connected with the first fastening element; and
the installation sleeve, sleeved outside the first fastening element and the second fastening element, and arranged between a head portion of the second fastening element and the circumferential collar with a clearance along an axial direction.

18. The spray gun according to claim 17, wherein
the circumferential collar and the threaded portion of the first fastening element are located at a first end of the first fastening element, the first fastening element internally has a threaded hole opened towards a second end of the first fastening element;
the second fastening element has a rod portion and a head portion, the rod portion of the second fastening element matches the threaded hole of the first fastening element, and the head portion of the second fastening element presses against the second end of the first fastening element.

19. The spray gun according to claim 18, wherein the fastening means further comprises a ring, the head portion of the second fastening element presses against the second end of the first fastening element in a manner of the ring being sandwiched between the head portion of the second fastening element and the second end of the first fastening element.

20. The spray gun according to claim 18, wherein the installation sleeve has a first end provided on the connecting arm and a second end against which the circumferential collar abuts, and a distance from the second end of the first fastening element to the second end of the installation sleeve is bigger than a distance from the first end of the installation sleeve to the second end of the installation sleeve.

21. The spray gun according to claim 18, wherein the connecting arm is provided with a recess so that the rod portion of the second fastening element passes through the recess to be thereby fastened into the threaded hole of the first fastening element, and the head portion of the second fastening element is arranged in the recess.

22. The spray gun according to claim 19, wherein the first fastening element, the second fastening element and the ring are fixed against each other, and the installation sleeve is rotatable with respect to these components as a whole.

23. The spray gun according to claim 19, wherein there is a gap between the first end of the installation sleeve provided on the connecting arm and an end of the ring abutting against the second end of the first fastening element.

24. The spray gun according to claim 13, wherein the installation sleeve and the connecting arm are formed in one piece.

25. The spray gun according to claim 12, wherein the actuating component comprises a first extension element and a second extension element extending from the connecting arm, and a gap is defined between the first extension element and the second extension element so as to make the paint needle pass therethrough.
